(19) United States
(12) Patent Application Publication
(10) Pub. No.: US 2026/0128711 A1
(43) Pub. Date: May 7, 2026

(54) PHOTOVOLTAIC MODULE INSTALLATION METHOD BASED ON SURFACE LINEAR FEATURES AND MODULE INSTALLATION ROBOT

(71) Applicant: Huzhou Leapting Technology Co., Ltd., Huzhou (CN)

(72) Inventors: Chenxin Zou, Huzhou (CN); Shitao Wang, Huzhou (CN); Ye Zhang, Huzhou (CN)

(73) Assignee: Huzhou Leapting Technology Co., Ltd., Huzhou (CN)

(21) Appl. No.: 19/326,815

(22) Filed: Sep. 12, 2025

(30) Foreign Application Priority Data
Nov. 4, 2024 (CN) 202411554060.8

(51) Int. Cl. H02S 99/00; B25J 9/16; B25J 19/02; G06T 1/00; G06T 7/60

(52) U.S. Cl. CPC H02S 99/00; B25J 9/161; B25J 9/163; B25J 9/1697; B25J 19/023; G06T 1/0014; G06T 7/60; G06T 2207/20032; G06T 2207/20061

(57) ABSTRACT

A photovoltaic module installation method based on surface linear features and a module installation robot are disclosed. The method comprises: grasping a to-be-installed module, moving it to a fine-tuning position and hovering it; obtaining a first image at the fine-tuning position, calculating the average angle between the horizontal lines of the to-be-installed module and a reference module based on the first image, and fine-tuning the to-be-installed module based on the average angle; obtaining a second image, calculating the actual distance between the corresponding vertical lines of the two modules and the actual distance between the edges of the two modules based on the second image; fine-tuning the to-be-installed module horizontally based on the former, and fine-tuning the to-be-installed module vertically based on the latter; and pressing the to-be-installed module downward to the installation location. The present application reduces installation errors and improves the installation accuracy of photovoltaic modules.

### FIELD OF THE DISCLOSURE

The present application relates to the field of photovoltaic module installation, in particular to a photovoltaic module installation method based on surface linear features and a module installation robot.

### BACKGROUND

Photovoltaic modules can convert solar energy into electricity and are essential for using clean energy. However, setting up a photovoltaic power station requires huge labor and is extremely dangerous. Now, autonomous installation of photovoltaic modules is possible with module installation robots. These robots use visual recognition to determine the installation location of the photovoltaic modules and then install these photovoltaic modules. However, factors such as the long-distance movement of the robotic arm can lead to large installation errors, currently the rough installation is possible, and the installation errors is difficult to control.

### SUMMARY OF THE INVENTION

One of the purposes of the present application is to address the problems existing in the prior art and provide a photovoltaic module installation method based on surface linear features and a module installation robot.

The technical solutions provided by the present application are as follows:

A photovoltaic module installation method based on surface linear features is used for a module installation robot. The module installation robot comprises a robotic arm and a camera located at an end of the robotic arm. The installation method comprises:
grasping a module to be installed via a robotic arm, moving the module to a fine-tuning position, and hovering it at the fine-tuning position, wherein the fine-tuning position is located above an installation location and spaced from the installation location by a first preset distance;
obtaining a first image including a reference module and the module to be installed via the camera, wherein the reference module is a previously installed photovoltaic module immediately close to the module to be installed;
calculating an average angle between horizontal lines of the reference module and horizontal lines of the module to be installed in the first image, and performing a first fine-tuning adjustment on the module to be installed based on the average angle so that the horizontal lines of the reference module and the horizontal lines of the module to be installed are parallel;
obtaining a second image including the reference module and the first fine-tuned module to be installed via the camera;
calculating a first actual distance between vertical lines of the reference module and vertical lines of the corresponding module to be installed, and a second actual distance between a lower edge horizontal line of the reference module and an upper edge horizontal line of the module to be installed based on the second image;
translating the module to be installed along a horizontal direction based on the first actual distance so as to align the vertical lines of the reference module with the vertical lines of the corresponding module to be installed;
translating the module to be installed along a vertical direction based on the second actual distance so as to maintain a second preset distance between the reference module and the module to be installed;
pressing the module to be installed downward to the installation location.

In some embodiments, said calculating an average angle between horizontal lines of the reference module and horizontal lines of the module to be installed in the first image comprises:
determining edges of the reference module and the module to be installed in the first image;
distinguishing the reference module and the module to be installed in the first image based on the edges;
calculating an average inclination angle of the horizontal lines of the reference module in the first image;
calculating an average inclination angle of the horizontal lines of the module to be installed in the first image;
obtaining the average angle between the horizontal lines of the reference module and the horizontal lines of the module to be installed based on the average inclination angle of the horizontal lines of the reference module and the average inclination angle of the horizontal lines of the module to be installed.

In some embodiments, said determining edges of the reference module and the module to be installed in the first image comprises:
performing a morphological opening operation on the first image, and then extracting edge horizontal lines of the two modules in the first image using a Hough detection algorithm;
obtaining intersection points between the edge horizontal lines and a first vertical detection line, wherein the first vertical detection line is a straight line located at a center of the first image and parallel to a Y-axis;
clustering the edge horizontal lines based on vertical coordinates of the intersection points to obtain a plurality of clusters, and identifying a position of the corresponding edge horizontal line by using a midpoint value of each cluster;
calculating an intermediate value between a topmost cluster and a bottommost cluster, wherein the edge horizontal lines of the clusters located above the intermediate value are determined as the edge horizontal lines of the reference module, and the edge horizontal lines of the clusters located below the intermediate value are determined as the edge horizontal lines of the module to be installed, thereby identifying the edges of the reference module and the module to be installed in the first image.

In some embodiments, said calculating an average inclination angle of the horizontal lines of the reference module in the first image comprises:
extracting all horizontal lines of the reference module using a Hough detection algorithm, and obtaining an inclination angle for each the horizontal line of the reference module;
obtaining intersection points between the horizontal lines and the first vertical detection line;
clustering the horizontal lines based on vertical coordinates of the intersection points to obtain a plurality of clusters;
performing a median filtering on inclination angles of the horizontal lines within each cluster, and constructing a first point set using the inclination angles of remaining horizontal lines after filtering and vertical coordinates of their intersection points between the first vertical detection line and remaining horizontal lines after filtering, wherein for each point in the first point set, its horizontal coordinate is a vertical coordinate of the intersection point between the remaining horizontal lines after median filtering and the first vertical detection line, and its vertical coordinate is the inclination angle of remaining horizontal lines after filtering;
fitting the first point set to obtain a first linear equation, wherein the average inclination angle of all horizontal lines of the reference module is equal to an intercept b1 of the first linear equation.

In some embodiments, said calculating an average inclination angle of the horizontal lines of the module to be installed in the first image comprises:
extracting the horizontal lines of the module to be installed in the first image using a Hough detection algorithm, and obtaining an inclination angle for each horizontal line;
obtaining intersection points between the horizontal lines of the module to be installed and the first vertical detection line;
clustering the horizontal lines of the module to be installed based on vertical coordinates of the intersection points to obtain a plurality of clusters;
performing a median filtering on inclination angles of the horizontal lines within each cluster, and constructing a second point set using the inclination angles of remaining horizontal lines after filtering and vertical coordinates of their intersection points between the first vertical detection line and remaining horizontal lines after filtering, wherein for each point in the second point set, its horizontal coordinate is a vertical coordinate of the intersection point between the remaining horizontal lines after median filtering and the first vertical detection line, and its vertical coordinate is the inclination angle of remaining horizontal lines after filtering;
fitting the second point set with a second linear equation, wherein a slope of the second linear equation is equal to a slope of the first linear equation, which comprises:
substituting each point in the second point set into the second linear equation to obtain a corresponding intercept value of the second linear equation, and averaging all intercept values to obtain an intercept of the second linear equation;
wherein the average inclination angle of all horizontal lines of the module to be installed is equal to the intercept b2 of the second linear equation.

In some embodiments, said calculating a first actual distance between vertical lines of the reference module and vertical lines of the corresponding module to be installed based on the second image comprises:
determining edges of the reference module and the module to be installed in the second image, and identifying the lower edge horizontal line of the reference module and the upper edge horizontal line of the module to be installed;
distinguishing the reference module and the module to be installed in the second image based on the edges, and determining a range of the reference module and a range of the module to be installed;
extracting a vertical line of the reference module and a vertical line of the corresponding module to be installed from the second image as an upper module reference line and a lower module reference line, respectively;
extracting vertical lines of the reference module and the module to be installed other than the upper module reference line and the lower module reference line from the second image;
using horizontal coordinate values of first-type intersection points between a first horizontal detection line and the vertical lines of the reference module to identify positions of corresponding vertical lines, and using horizontal coordinate values of second-type intersection points between a second horizontal detection line and the vertical lines of the module to be installed to identify positions of corresponding vertical lines; wherein the first horizontal detection line is a straight line located in the range of the reference module and parallel to an X-axis, and the second horizontal detection line is a straight line located in the range of the module to be installed and parallel to the X-axis;
calculating relative positions of the vertical lines of the reference module with respect to the upper module reference line, calculating relative positions of the vertical lines of the module to be installed with respect to the lower module reference line; and matching the vertical lines of the reference module and the module to be installed having same relative positions to form vertical line pairs;
calculating a first pixel distance between the vertical line of the reference module and the vertical line of the corresponding module to be installed based on positions of any two vertical lines among all vertical line pairs;
obtaining a second scaling ratio r2 between a pixel distance and an actual distance within the range of the module to be installed in the second image;
multiplying the first pixel distance by the second scaling ratio r2 to obtain the first actual distance.

In some embodiments, said extracting a vertical line of the reference module and a vertical line of the corresponding module to be installed from the second image as an upper module reference line and a lower module reference line, respectively, comprises:
the second image comprises a first-type vertical line and a plurality of second-type vertical lines, wherein the first-type vertical line is wider than the second-type vertical line;
performing a morphological opening operation on the second image, and then extracting the first-type vertical line using a Hough detection algorithm, wherein the first-type vertical line located in the range of the reference module is used as the upper module reference line, and the first-type vertical line located in the range of the module to be installed is used as the lower module reference line.

In some embodiments, said using horizontal coordinate values of first-type intersection points between a first horizontal detection line and the vertical lines of the reference module to identify positions of corresponding vertical lines comprises:
selecting the first horizontal detection line located at a center of the range of the reference module, and obtaining the first-type intersection point between the upper module reference line and the first horizontal detection line;
clustering horizontal coordinates of the first-type intersection points to obtain a plurality of clusters; obtaining a midpoint value of each cluster, averaging the midpoint values of all clusters, and using an average value as a position identifier of the upper module reference line;
said using horizontal coordinate values of second-type intersection points between a second horizontal detection line and the vertical lines of the module to be installed to identify positions of corresponding vertical lines comprises:
selecting the second horizontal detection line located at a center of the range of the module to be installed, and obtaining the second-type intersection points between the lower module reference line and the second horizontal detection line;
clustering horizontal coordinates of the second-type intersection points to obtain a plurality of clusters; obtaining a midpoint value of each cluster, averaging the midpoint values of all clusters, and using an average value as a position identifier of the lower module reference line.

In some embodiments, said extracting vertical lines of the reference module and the module to be installed other than the upper module reference line and the lower module reference line from the second image comprises:
extracting the second-type vertical lines of the reference module and the second-type vertical lines of the module to be installed in the second image using a Hough detection algorithm;
said using horizontal coordinate values of first-type intersection points between a first horizontal detection line and the vertical lines of the reference module to identify positions of corresponding vertical lines comprises:
obtaining the first-type intersection points between the second-type vertical lines of the reference module and the first horizontal detection line;
clustering the second-type vertical lines of the reference module based on horizontal coordinates of the first-type intersection points to obtain a plurality of clusters, and using a midpoint value of each cluster as a position identifier of the second-type vertical line of the corresponding reference module;
said using horizontal coordinate values of second-type intersection points between a second horizontal detection line and the vertical lines of the module to be installed to identify positions of corresponding vertical lines comprises:
obtaining the second-type intersection points between the second-type vertical lines of the module to be installed and the second horizontal detection line;
clustering the second-type vertical lines of the module to be installed based on horizontal coordinates of the second-type intersection points to obtain a plurality of clusters, and using a midpoint value of each cluster as a position identifier of the second-type vertical line of the corresponding module to be installed.

In some embodiments, said calculating a first pixel distance between the vertical line of the reference module and the vertical line of the corresponding module to be installed based on positions of any two vertical lines among all vertical line pairs comprises:
constructing a third point set, wherein points of the third point set correspond to the vertical line pairs, and the horizontal coordinate value of each point in the third point set is the horizontal coordinate value of the first-type intersection point, and the vertical coordinate value is the horizontal coordinate value of the second-type intersection point;
fitting the third point set to obtain a third linear equation, wherein an independent variable of the third linear equation is a position of the vertical line of the reference module in the vertical line pairs, and a dependent variable is a position of the vertical line of the corresponding module to be installed;
obtaining a corresponding dependent variable based on the third linear equation when the independent variable is a horizontal coordinate value of a center of the second image, and subtracting the independent variable value from the dependent variable value to obtain the first pixel distance.

In some embodiments, said calculating a second actual distance between a lower edge horizontal line of the reference module and an upper edge horizontal line of the module to be installed based on the second image comprises:
calculating a pixel distance y1 from a center of the second image to the lower edge horizontal line of the reference module, and a pixel distance y2 from the center to the upper edge horizontal line of the module to be installed;
obtaining a first proportional relationship r1 between a pixel distance and an actual distance at the range of the reference module, and the second proportional relationship r2 between the pixel distance and the actual distance at the range of the module to be installed;
multiplying the pixel distance y1 by the first proportional relationship r1 to obtain the corresponding actual distance I;
multiplying the pixel distance y2 by the second proportional relationship r2 to obtain the corresponding actual distance II;
obtaining the second actual distance based on the actual distance I and the actual distance II.

In some embodiments, said obtaining a first proportional relationship r1 between a pixel distance and an actual distance at the range of the reference module comprises:
calculating distances between adjacent second-type vertical lines at the range of the reference module based on positions of the second-type vertical lines of the reference module;
obtaining a pixel length of a cell at the range of the reference module in the second image based on the distances between all adjacent second-type vertical lines at the range of the reference module;
obtaining the first proportional relationship r1 between the pixel distance and the actual distance at the range of the reference module based on the pixel length and an actual length of the cell at the range of the reference module;
said obtaining a second proportional relationship r2 between the pixel distance and an actual distance at the range of the module to be installed comprises:
calculating distances between adjacent second-type vertical lines at the range of the module to be installed based on positions of the second-type vertical lines of the module to be installed in the second image;
obtaining a pixel length of a cell at the range of the module to be installed in the second image based on the distances between all adjacent second-type vertical lines at the range of the module to be installed;
obtaining a second proportional relationship r2 between the pixel distance and an actual distance at the range of the module to be installed based on the pixel length and an actual length of the cell at the range of the module to be installed.

The present application further provides a module installation robot, which comprises:
a robotic arm, which is configured to grasp, move, and adjust a module to be installed;
a camera, which is located at an end of the robotic arm, configured for obtaining an image containing a reference module and the module to be installed;
a memory, which is configured to store computer programs;
a processor, which is configured to implement any of above-mentioned photovoltaic module installation methods based on surface linear features when running the computer programs.

The photovoltaic module installation method based on surface linear features and the module installation robot provided by the present application can at least bring the following beneficial effects:

The present application provides a method for installing a photovoltaic module by setting a fine-tuning position at a preset distance above the installation location of the photovoltaic module, identifying linear features on the surfaces of the reference module and the module to be installed at the fine-tuning position, and fine-tuning the position of the module to be installed based on the positional relationship of these linear features. The fine-tuning process ensures that the horizontal lines of the module to be installed are parallel to those of the reference module, the vertical lines are aligned, and a second preset distance is maintained between the modules in the vertical direction. After the fine-tuning is completed, the module to be installed is pressed downward to the installation location to complete the installation. This method reduces installation errors and improves the installation accuracy of photovoltaic modules.

### BRIEF DESCRIPTION OF THE DRAWINGS

The preferred embodiment will be described below in a clear and understandable manner with reference to the accompanying drawings, further illustrating the above-mentioned characteristics, technical features, advantages and implementation methods of the photovoltaic module installation method based on surface linear features and the module installation robot.

The patent or application file contains at least one drawing executed in color. Copies of this patent or patent application publication with color drawing(s) will be provided by the Office upon request and payment of the necessary fee.

FIG. 1 is a flow chart of an embodiment of a photovoltaic module installation method based on surface linear features of the present application;

FIG. 2 is a schematic structural diagram of an embodiment of a module installation robot of the present application;

FIG. 3 is a schematic diagram of the structure of the reference module and the module to be installed as seen from the perspective of the robot camera in a fine-tuning position;

FIG. 4 is a schematic diagram of a first image according to an embodiment of the present application;

FIG. 5 is a schematic diagram of an image obtained after performing a morphological opening operation on the first image and extracting horizontal lines using the Hough detection algorithm.

### DESCRIPTION OF THE ILLUSTRATED EMBODIMENTS

In order to more clearly illustrate the embodiments of the present application or the technical solutions in the prior art, the specific embodiments of the present application will be described below with reference to the accompanying drawings. Obviously, the drawings described below are only some embodiments of the present application. For those skilled in the art, other drawings and other embodiments can be obtained based on these drawings without inventive work.

To simplify the drawings, only the parts relevant to the present application are schematically depicted in each figure; they do not represent the actual structure of the product. Furthermore, to simplify the drawings and facilitate understanding, in some figures, only one module with the same structure or function is schematically depicted or labeled. In this document, “one” not only means “only one” but also “more than one”; “robot” and “module installation robot” have the same meaning.

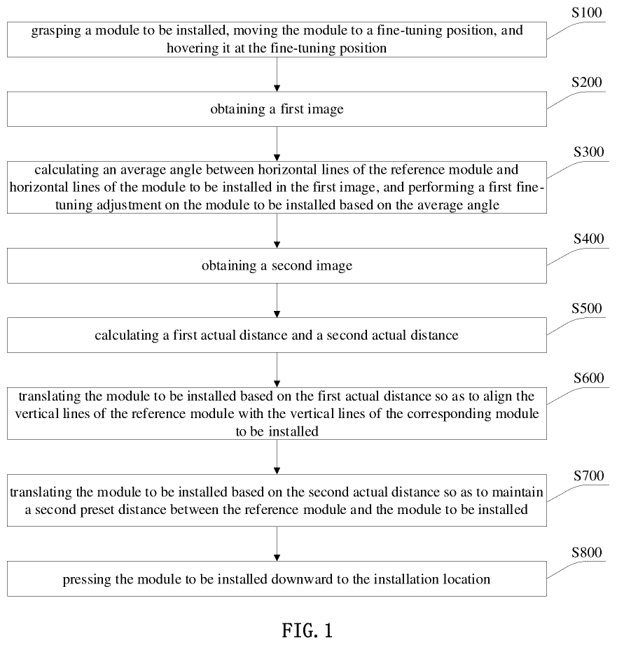

One embodiment of the present application, as shown in FIG. 1, provides a photovoltaic module installation method based on surface linear features, which is used in a module installation robot. The module installation robot comprises a robotic arm and a camera located at an end of the robotic arm. The installation method comprises:
Step S100: grasping a module to be installed via a robotic arm, moving the module to a fine-tuning position, and hovering it at the fine-tuning position, wherein the fine-tuning position is located above an installation location and spaced from the installation location by a first preset distance.

Specifically, the module installation robot is used to install photovoltaic modules onto photovoltaic brackets. The end of the robotic arm grasps, moves, and adjusts the photovoltaic modules. A camera is also mounted on the end of the robotic arm to provide visual positioning information for the robot.

The “module to be installed” refers to the photovoltaic module to be installed. The installation location can be identified by a preset point within the photovoltaic module's installation area. The installation location of the module to be installed can be predetermined based on the design plan of the photovoltaic power plant and input to the module installation robot. A fine-tuning position is set above the installation location, with a height difference of a first preset distance, such as 5 cm. For example, the installation location is set to the center of the installation area. The robot uses its robotic arm to grasp the module to be installed and move it so that the center point of the module to be installed reaches the fine-tuning position, where it hovers.
Step S200: obtaining a first image including a reference module and the module to be installed via the camera, wherein the reference module is a previously installed photovoltaic module immediately close to the module to be installed.

The reference module is the previously installed photovoltaic module. For example, when installing from left to right, the first photovoltaic module can be installed using the traditional method, serving as the reference module for the next photovoltaic module. The second photovoltaic module can then be installed using the method described in this embodiment. The third photovoltaic module can then be installed using the second photovoltaic module as the reference module, and this cycle continues until the photovoltaic modules in a line are complete. Installation can also be done from right to left, top to bottom, or bottom to top. There are no restrictions for the installation direction; simply use the previously installed photovoltaic module as the reference module for the next module to be installed.

The camera is located above the photovoltaic module to be installed, with a certain height difference. When the robotic arm moves the module to be installed to the fine-tuning position, the robot can capture an image containing the reference module and the module to be installed by looking down through the assembled camera. FIG. 3 is a structural diagram of the image seen within the camera's field of view at the fine-tuning position. The image space is divided into the range of the reference module, the gap, and the range of the module to be installed. The image of the range of the reference module belongs to the reference module, and the image of the range of the module to be installed belongs to the module to be installed, with a certain gap between the two modules. FIG. 4 is a specific image taken by the camera. From top to bottom, there are images of part of the reference module, the gap, and part of the module to be installed. There are perpendicular lines on the module images.

Photovoltaic modules have white lines on the surface, including multiple parallel horizontal and vertical lines, mutually perpendicular. These lines connect the cells, connecting them in series or parallel to form a complete circuit, thus generating electricity.

Obtain the first image using the camera at the fine-tuning position. This first image contains the horizontal and vertical lines of the photovoltaic module, as shown in FIG. 4. Establish an x-y-z coordinate system with the upper left corner of the image as the origin. The horizontal direction of the image is the X-axis (parallel to the upper edge of the image), the vertical direction is the Y-axis (parallel to the left edge of the image), the plane of the reference module is the x-y plane, and the Z-axis is perpendicular to the x-y plane.

It should be noted that the vertical and horizontal lines in this article refer specifically to the white lines on the surface of the reference module/module to be installed. In the camera image, the horizontal lines of the reference module/module to be installed are not necessarily parallel to the X-axis, and the vertical lines are not necessarily parallel to the Y-axis.
Step S300: calculating an average angle between horizontal lines of the reference module and horizontal lines of the module to be installed in the first image, and performing a first fine-tuning adjustment on the module to be installed based on the average angle so that the horizontal lines of the reference module and the horizontal lines of the module to be installed are parallel.

An existing straight line detection algorithm can be used, for example, the Hough detection algorithm is used to detect the horizontal lines on the reference module and the module to be installed in the first image. When a horizontal line is detected, the Hough detection algorithm simultaneously outputs the inclination angle of the horizontal line, that is, the angle between the horizontal line and the X-axis. An average inclination angle I is obtained based on the inclination angles of multiple horizontal lines on the reference module. An average inclination angle II is obtained based on the inclination angles of multiple horizontal lines on the module to be installed. Based on the average inclination angle I and the average inclination angle II, the average angle between the horizontal lines of the reference module and the horizontal lines of the module to be installed can be calculated. The rotational freedom of the module to be installed about the Z-axis is then adjusted based on this average angle, so that the horizontal lines of the reference module are parallel to the horizontal lines of the module to be installed.
Step S400: obtaining a second image including the reference module and the first fine-tuned module to be installed via the camera.
Step S500: calculating a first actual distance between vertical lines of the reference module and vertical lines of the corresponding module to be installed, and a second actual distance between a lower edge horizontal line of the reference module and an upper edge horizontal line of the module to be installed based on the second image.
Step S600: translating the module to be installed along a horizontal direction based on the first actual distance so as to align the vertical lines of the reference module with the vertical lines of the corresponding module to be installed.
Step S700: translating the module to be installed along a vertical direction based on the second actual distance so as to maintain a second preset distance between the reference module and the module to be installed.
Step S800: pressing the module to be installed downward to the installation location.

Specifically, after the first fine-tuning process, the horizontal lines of the module to be installed are parallel to the horizontal lines of the reference module. Therefore, in the second image, the horizontal lines of the module to be installed are parallel to the horizontal lines of the reference module, and the vertical lines of the module to be installed may be aligned with the vertical lines of the reference module, or may be parallel but not aligned.

Existing line detection algorithms, such as the Hough detection algorithm, can be used to detect vertical lines on the reference module and the module to be installed in the second image. A first pixel distance between the vertical lines of the reference module and the vertical lines of the corresponding module to be installed in the second image is calculated.

A pixel distance is not equal to an actual distance. It should be converted to an actual distance based on the relationship between the pixel distance and the actual distance. This relationship depends on the camera's resolution, the object distance, and the subject distance at the time of capture, and can be predetermined. The first pixel distance is then converted to the first actual distance. This first actual distance represents the horizontal translation of the module to be installed. The module to be installed is adjusted based on this horizontal translation to align the reference module with the corresponding vertical lines of the module to be installed.

Similarly, the Hough detection algorithm can be used to identify the lower edge horizontal line of the reference module and the upper edge horizontal line of the module to be installed in the second image, calculate the second pixel distance between them, and then, based on the relationship between the pixel distance and the actual distance, determine the corresponding second actual distance. The difference between the second actual distance and the second preset distance is used to determine the vertical translation of the module to be installed. The module to be installed is then adjusted based on the vertical translation to maintain the second preset vertical distance between the reference module and the module to be installed.

By fine-tuning the module to be installed at the fine-tuning position, the module to be installed and the reference module are not only parallel to the horizontal lines and aligned with the corresponding vertical lines, but also maintain a second preset distance in the vertical direction. The module to be installed is then pressed down to the installation location, thereby completing the installation of the photovoltaic module.

In this embodiment, by setting a fine-tuning position, without adding additional sensors, the module to be installed is first fine-tuned into the fine-tuning position based on the appearance characteristics of the photovoltaic module (i.e., the lines on the surface), and then the module to be installed is pressed down. This reduces installation errors and improves the installation accuracy of the photovoltaic module.

In one embodiment, the step S300 calculating an average angle between horizontal lines of the reference module and horizontal lines of the module to be installed in the first image, comprises:
Step S310: determining edges of the reference module and the module to be installed in the first image, and distinguishing the reference module and the module to be installed in the first image based on the edges;
Step S320: calculating an average inclination angle of the horizontal lines of the reference module in the first image;
Step S330: calculating an average inclination angle of the horizontal lines of the module to be installed in the first image;
Step S340: obtaining the average angle between the horizontal lines of the reference module and the horizontal lines of the module to be installed based on the average inclination angle of the horizontal lines of the reference module and the average inclination angle of the horizontal lines of the module to be installed.

In one embodiment, the step S310 determining edges of the reference module and the module to be installed in the first image comprises:
Step S311: performing a morphological opening operation on the first image, and then extracting edge horizontal lines of the two modules in the first image using a Hough detection algorithm;
Step S312: obtaining intersection points between the edge horizontal lines and a first vertical detection line, wherein the first vertical detection line is a straight line located at a center of the first image and parallel to a Y-axis;
Step S313: clustering the edge horizontal lines based on vertical coordinates of the intersection points to obtain a plurality of clusters, and identifying a position of each edge horizontal line by using a midpoint value of a corresponding cluster;
Step S314: calculating an intermediate value between a topmost cluster and a bottommost cluster, wherein the edge horizontal lines of the clusters located above the intermediate value are determined as the edge horizontal lines of the reference module, and the edge horizontal lines of the clusters located below the intermediate value are determined as the edge horizontal lines of the module to be installed, thereby identifying the edges of the reference module and the module to be installed in the first image.

Specifically, the morphological opening operation is used to remove small details and noise from an image without affecting the structure of larger objects. The process involves first performing an erosion operation on the image and then performing a dilation operation on the resulting image. Erosion reduces the size of foreground objects and removes small protrusions, while dilation increases the size of foreground objects.

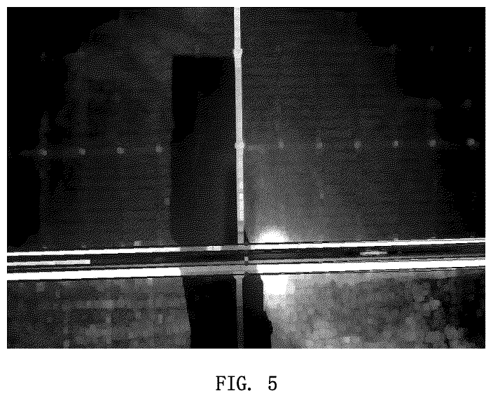

As shown in FIG. 5, the morphological opening operation is first performed on the first image to remove thin lines, remaining thick lines. Based on this, the Hough detection algorithm is then used to extract the horizontal lines in the first image, obtaining the edge horizontal lines of the two modules (such as the blue lines in FIG. 5). Due to the frame of the photovoltaic module (see the white portion between the upper and lower edge horizontal lines in FIG. 5), the upper and lower edge horizontal lines of the frame are identified, thus obtaining the upper and lower edge horizontal lines of the lower frame of the reference module, as well as the upper and lower edge horizontal lines of the upper frame of the module to be installed.

The position of the edge horizontal lines can be identified by the ordinate of its intersection with the first vertical detection line. The first vertical line can be any line parallel to the Y-axis of the first image. Because images captured by cameras exhibit “distortion” where objects appear larger near and smaller far away, a line located at the center of the first image and parallel to the Y-axis is preferably used as the first vertical detection line, for example, x=cols/2, where cols is the width of the first image.

Ideally, a single straight line would be detected through the line detection algorithm. However, in practice, multiple straight lines may be detected. For example, there are multiple lower edge horizontal lines (blue lines) of the lower frame of the reference module in FIG. 5. Therefore, it is necessary to cluster the horizontal lines according to the ordinate of the intersection points of the edge horizontal lines and the first vertical detection line. The edge horizontal lines belonging to the same cluster can be fused into one edge horizontal line, and the midpoint value of the cluster (such as the ordinate value of the red point in FIG. 5) is used to identify the position of the fused edge horizontal line.

Based on the positions of the edge horizontal lines of the reference module and the position of the edge horizontal lines of the module to be installed, the edges of the two modules in the first image are determined, thereby determining the range of the reference module and the range of the module to be installed. There are several specific methods. As shown in FIG. 5, the midpoint values of the four clusters can be sorted from smallest to largest. Assuming the Y-axis increases from top to bottom, the edge horizontal lines belonging to the first two clusters are the edge horizontal lines of the reference module, and the edge horizontal lines belonging to the last two clusters are the edge horizontal lines of the module to be installed.

Alternatively, the intermediate value between the two middle clusters can be calculated (i.e., the vertical coordinate value of the green point, which may be obtained either by averaging the midpoint values of the two middle clusters or by determining the median based on the four clusters). The edge horizontal lines belonging to the cluster located above the intermediate value is identified as the edge horizontal lines of the reference module, while the edge horizontal lines belonging to the cluster located below the intermediate value is identified as the edge horizontal lines of the module to be installed.

Alternatively, as described in the step S314, the average of the midpoint values of the top and bottom clusters may be taken as the intermediate value, and the edges of the two modules may be distinguished based on the intermediate value. Since the top and bottom clusters are far apart, they are easier to identify and locate than the two middle clusters.

The range enclosed by the edge horizontal lines of the reference module extending upward belongs to the range of the reference module, and the range enclosed by the edge horizontal lines of the module to be installed extending downward is the range of the module to be installed.

In one embodiment, the step S320 comprises:
Step S321: extracting all horizontal lines of the reference module using a Hough detection algorithm, and obtaining an inclination angle for each horizontal line of the reference module;
Step S322: obtaining intersection points between the horizontal lines and the first vertical detection line;
Step S323: clustering the horizontal lines based on vertical coordinates of the intersection points to obtain a plurality of clusters;
Step S324: performing a median filtering on inclination angles of the horizontal lines within each cluster;
Step S325: constructing a first point set using the inclination angles of remaining horizontal lines after filtering and vertical coordinates of their intersection points with the first vertical detection line, wherein each point in the first point set corresponds one-to-one with the intersection point between the remaining horizontal lines after filtering and the first vertical detection line, a horizontal coordinate is a vertical coordinate of the corresponding intersection point and a vertical coordinate is the inclination angle of horizontal lines to which the corresponding intersection point belongs.
Step S326: fitting the first point set to obtain a first linear equation, wherein the average inclination angle of all horizontal lines of the reference module is equal to an intercept b1 of the first linear equation.

Specifically, the Hough detection function is directly used to extract the horizontal lines in the first image, and the horizontal lines of the reference module and the horizontal lines of the modules to be installed are distinguished based on their edges. Although the method provided in steps S321 to S326 is used to calculate the inclination angle of the horizontal lines of the reference module, a similar method can be used to calculate the inclination angle of the horizontal lines of the modules to be installed, and will not be described in detail here.

The position of the horizontal lines of the reference module and the module to be installed can be identified by the vertical coordinate of its intersection point with the first vertical detection line. Alternatively, the first vertical line may be replaced with a second vertical detection line, which is a straight line parallel to the first vertical line but not located at the center of the image. In this case, the position of the horizontal line is identified by the vertical coordinate of its intersection point with the second vertical detection line.

The horizontal lines of the reference module are clustered to obtain several clusters, and then the inclination angles of the horizontal lines belonging to the same cluster are median filtered to remove some horizontal lines.

Construct the first point set (y1, θ1), where the horizontal coordinate y1 of each point is the vertical coordinate value of the intersection point of the horizontal line to which the point belongs and the first vertical detection line, and θ1 is the inclination angle of the horizontal line to which the point belongs. Use the least squares method to fit these points to the first linear equation θ1=k1*y1+b1, where k1 is the slope and b1 is the intercept. The independent variable of the first linear equation is the vertical coordinate of the intersection point of the horizontal line of the reference module and the first vertical detection line, and the dependent variable is the inclination angle of the horizontal lines of the reference module.

Since the horizontal lines of the reference module are parallel to each other and have the same inclination angle, the slope k1 of the first linear equation approaches 0, so the average inclination angle of the horizontal lines of the reference module is equal to the intercept b1 of the first linear equation.

In one embodiment, the step S330 comprises:
Step S331: extracting the horizontal lines of the module to be installed in the first image using a Hough detection algorithm, and obtaining an inclination angle for each horizontal line;
Step S332: obtaining intersection points between the horizontal lines of the module to be installed and the first vertical detection line;
Step S333: clustering the horizontal lines of the module to be installed based on vertical coordinates of the intersection points to obtain a plurality of clusters;
Step S334: performing a median filtering on inclination angles of the horizontal lines within each cluster;
Step S335: constructing a second point set using the inclination angles of remaining horizontal lines after filtering and vertical coordinates of the intersection points between the remaining horizontal lines after filtering and the first vertical detection line, wherein each point in the second point set corresponds one-to-one with the intersection point between the remaining horizontal lines after filtering and the first vertical detection line, a horizontal coordinate is a vertical coordinate of the corresponding intersection point and a vertical coordinate is the inclination angle of horizontal lines to which the corresponding intersection point belongs;
Step S336: fitting the second point set with a second linear equation, wherein a slope of the second linear equation is equal to a slope of the first linear equation, which comprises:
substituting each point in the second point set into the second linear equation to obtain corresponding intercept values of the second linear equation, and averaging all intercept values to obtain an intercept of the second linear equation;
wherein the average inclination angle of all horizontal lines of the module to be installed is equal to the intercept b2 of the second linear equation.

Specifically, the steps S331 to S335 are similar to the steps S321 to S325 and are not described in detail here. The difference lies in step S336.

Since the range of the module to be installed that can be captured by the camera is smaller than the range of the reference module, there are fewer horizontal lines of the module to be installed in the image, and fewer intersections with the first vertical detection line. The number of points in the second point set will be relatively small, and forced fitting will cause large errors. Therefore, step S336 is used to derive the equation of the second line.

Assume that the second point set (y2, θ2) is approximately on the second linear equation θ2=k2*y2+b2, wherein k2 is the slope, b2 is the intercept, the horizontal coordinate y2 of each point in the second point set is the vertical coordinate value of the intersection point of the horizontal line to which the point belongs and the first vertical detection line, and θ2 is the inclination angle of the horizontal line to which the point belongs.

The slope k2 of the second linear equation should also tend to 0. Take k2=k1, substitute each point of the second point set into the second linear equation, obtain the corresponding b2 value, and then average these b2 values, and use the obtained average value as the intercept b2 of the second linear equation.

Since the slope k2 approaches 0, the average inclination angle of the horizontal lines of the modules to be installed is equal to the intercept b2 of the second linear equation.

The same method as calculating the average inclination angle of the horizontal lines of the reference module can also be used to substitute the first vertical line with the second vertical line.

In one embodiment, the step S500 calculating a first actual distance between vertical lines of the reference module and vertical lines of the corresponding module to be installed based on the second image, comprises:
Step S510: determining edges of the reference module and the module to be installed in the second image, and identifying the lower edge horizontal line of the reference module and the upper edge horizontal line of the module to be installed;
Step S520: distinguishing the reference module and the module to be installed in the second image based on the edges, and determining a range of the reference module and a range of the module to be installed;
Step S530: extracting vertical lines of the reference module and vertical lines of the corresponding module to be installed from the second image as an upper module reference line and a lower module reference line, respectively, and identifying their positions;
Step S540: extracting vertical lines of the reference module and the module to be installed other than the upper module reference line and the lower module reference line from the second image, and identifying their positions;
Step S550: using horizontal coordinate values of first-type intersection points between a first horizontal detection line and the vertical lines of the reference module to identify positions of corresponding vertical lines, and using horizontal coordinate values of second-type intersection points between a second horizontal detection line and the vertical lines of the module to be installed to identify positions of corresponding vertical lines; wherein the first horizontal detection line is a line located in the range of the reference module and parallel to an X-axis, and the second horizontal detection line is a line located in the range of the module to be installed and parallel to the X-axis;
calculating relative positions of the vertical lines of the reference module with respect to the upper module reference line, calculating relative positions of the vertical lines of the module to be installed with respect to the lower module reference line; and matching the vertical lines of the reference module and the module to be installed having same relative positions to form vertical line pairs;
Step S560: calculating a first pixel distance between the vertical line of the reference module and the vertical line of the corresponding module to be installed based on positions of all vertical line pairs;
Step S570: obtaining a second scaling ratio r2 between a pixel distance and an actual distance within the range of the module to be installed in the second image;
Step S580 multiplying the first pixel distance by the second scaling ratio r2 to obtain the first actual distance.

Specifically, a method similar to the steps S311 to S314 can be used to determine the edges of the reference module and the module to be installed in the second image, and the extracted lower edge horizontal line of the lower frame of the reference module is used as the lower edge horizontal line of the reference module, and the upper edge horizontal line of the upper frame of the module to be installed is used as the upper edge horizontal line of the module to be installed.

The reference module and the module to be installed in the second image are distinguished according to the edges, and the range of the reference module and the range of the module to be installed in the second image are determined.

Then the upper and lower module reference lines in the second image, as well as the vertical lines of the upper and lower modules other than the reference lines are determined. The upper module is the reference module, and the lower module is the module to be installed.

Mark the positions of the vertical lines of the upper and lower modules, including the positions of the upper and lower module reference lines. The horizontal coordinate values of the first intersection points of the first horizontal detection line and the vertical lines of the reference module (including the upper module reference line) can be used to identify the positions of the corresponding vertical lines. The first horizontal detection line is a line located within the range of the reference module and parallel to the X-axis. The horizontal coordinate values of the second intersection points of the second horizontal detection line and the vertical lines of the module to be installed (including the lower module reference line) can be used to identify the positions of the corresponding vertical lines. The second horizontal detection line is a line located within the module to be installed and parallel to the X-axis.

Calculate the relative position of the vertical lines of the upper module relative to the upper module reference line. For example, the relative position is expressed by subtracting the difference between the horizontal coordinate value of the first intersection point of the vertical lines of the upper module and the first-type horizontal detection line from the horizontal coordinate value of the first-type intersection point of the upper module reference line and the first-type horizontal detection line.

Similarly, calculate the relative position of the vertical lines of the module to be installed relative to the reference line of the lower module. Pair the vertical lines of the upper and lower modules that have the same relative position. The same relative position means that the vertical lines of the upper and lower modules are on the same side of the corresponding reference line and are close to each other, meaning the distance difference is within the threshold.

For example, the average distance between adjacent vertical lines can be calculated based on the vertical line position identifiers. If a vertical line is to the left of the reference line and is approximately 2 average distances away, it indicates that the vertical line is located second to the left of the reference line. The vertical line of the reference module located second to the left of the upper module reference line and the vertical line of the module to be installed located second to the left of the lower module reference line are paired.

The pixel distance between the two vertical lines in each vertical line pair can be calculated based on their positions in the second image, serving as the pixel distance of the corresponding vertical line pair. The average of the pixel distances of all or some of the vertical line pairs is calculated and used as the first pixel distance between the vertical line of the reference module and the vertical line of the corresponding module to be installed. The first pixel distance is then converted into the corresponding first actual distance.

In one embodiment, the step S530 comprises:
the second image comprises a first-type vertical line and a plurality of second-type vertical lines, wherein the first-type vertical line is wider than the second-type vertical line.
Step S531: performing a morphological opening operation on the second image, and then extracting the first-type vertical line using a Hough detection algorithm, wherein the first-type vertical line located in the range of the reference module is used as the upper module reference line, and the first-type vertical line located in the range of the module to be installed is used as the lower module reference line;
Step S532: selecting a line located within the range of the reference module and parallel to the X-axis as the first horizontal detection line, and obtaining the first-type intersection point between the upper module reference line and the first horizontal detection line;
Step S533: obtaining the position identifier of the upper module reference line based on the horizontal coordinate of the first-type intersection point;
Step S534: selecting a line located within the range of the module to be installed and parallel to the X-axis as the second horizontal detection line, and obtaining the second-type intersection point between the lower module reference line and the second horizontal detection line;
Step S535: obtaining the position identifier of the lower module reference line based on the horizontal coordinate of the second-type intersection point.

Specifically, as shown in FOG. 4, there are two types of vertical lines on the surface of the photovoltaic module, wherein the thick white line in the middle is the first-type vertical line, and the other thin white lines are the second-type vertical lines. The first-type vertical line is preferred as the reference line.

By performing a morphological opening operation on the second image and then using the Hough detection algorithm to extract vertical lines, the first-type vertical lines can be extracted and used as reference lines. The first-type vertical lines within the range of the reference module are used as the upper module reference line, and the first-type vertical lines within the range of the module to be installed are used as the lower module reference line.

For some photovoltaic modules, there may be no first-type vertical lines, and all are second-type vertical lines. In this case, step S531 can be changed to: using the Hough detection algorithm to extract vertical lines, and select a pair of vertical lines corresponding to the upper and lower modules from the extracted vertical lines as the upper module reference line and the lower module reference line respectively. The subsequent processing steps are the same.

The first horizontal detection line can be any straight line in the range of the reference module that is parallel to the X-axis of the second image, preferably the first horizontal detection line located at the center of the range of the reference module. The second horizontal detection line can be any straight line in the range of the module to be installed that is parallel to the X-axis of the second image, preferably the second horizontal detection line located at the center of the range of the module to be installed.

The position of the upper module reference line is identified by the horizontal coordinate value of the intersection point of the upper module reference line and the first horizontal detection line. The position of the lower module reference line is identified by the horizontal coordinate value of the intersection point of the lower module reference line and the second horizontal detection line.

In one embodiment, the step S533 obtaining the position identifier of the upper module reference line based on the horizontal coordinate of the first-type intersection point, or the step S535 obtaining the position identifier of the lower module reference line based on the horizontal coordinate of the second-type intersection point, comprises: clustering the horizontal coordinates of the first-type intersection point/the second-type intersection point to obtain a plurality of clusters; obtaining a midpoint value of each cluster, averaging the midpoint values of all clusters, and using an average value as a position identifier of the upper module reference line/the lower module reference line.

If the reference line is a thicker straight line, the line detection algorithm may detect multiple vertical lines. The average value of the horizontal coordinates of all intersection points can be used to identify the position of the reference line. In this embodiment, the average value of the midpoint values of all clusters is used to identify the position of the reference line, making the position identifier more accurate.

In one embodiment, the step S540 extracting vertical lines of the reference module and the module to be installed other than the upper module reference line and the lower module reference line from the second image comprises:
Step S541: extracting the second-type vertical lines of the reference module and the second-type vertical lines of the module to be installed in the second image using a Hough detection algorithm;
Step S542: obtaining the first-type intersection points between the second-type vertical lines of the reference module and the first horizontal detection line;
Step S543: clustering the second-type vertical lines of the reference module based on horizontal coordinates of the first-type intersection points to obtain a plurality of clusters, and using a midpoint value of each cluster as a position identifier of the second-type vertical line of the corresponding reference module;
Step S544: obtaining the second-type intersection points between the second-type vertical lines of the module to be installed and the second horizontal detection line;
step S545: clustering the second-type vertical lines of the module to be installed based on horizontal coordinates of the second-type intersection points to obtain a plurality of clusters, and using a midpoint value of each cluster as a position identifier of the second-type vertical line of the corresponding module to be installed.

In one embodiment, the step S560 calculating a first pixel distance between the vertical line of the reference module and the vertical line of the corresponding module to be installed based on positions of all vertical line pairs comprises:
Step S561: constructing a third point set, wherein points of the third point set correspond one-to-one to the vertical line pairs, and the horizontal coordinate value of each point in the third point set is the horizontal coordinate value of the first-type intersection point, and the vertical coordinate value is the vertical coordinate value of the second-type intersection point;
Step S562: fitting the third point set to obtain a third linear equation, wherein an independent variable of the third linear equation is a position of the vertical line of the reference module in the vertical line pairs, and a dependent variable is a position of the vertical line of the corresponding module to be installed;
Step S563: obtaining the value of the dependent variable corresponding to a preset value of the independent variable from the third linear equation, and subtracting the preset value from the dependent variable value to obtain a first pixel distance.

Specifically, a third point set is constructed based on the matching vertical line pairs, wherein the points (x1, x2) of the third point set correspond one-to-one to the vertical line pairs, x1 is the horizontal coordinate value of the first-type intersection point of the vertical line of the reference module and the first horizontal detection line, which is used to identify the position of the vertical line of the reference module; x2 is the horizontal coordinate value of the second-type intersection point of the vertical line of the corresponding module to be installed and the second horizontal detection line, which is used to identify the position of the vertical line of the module to be installed.

The third point set can be fitted using the least squares method to obtain the third linear equation x2=k3*x1+b3. The independent variable x1 is taken as the horizontal coordinate of the image center of the second image. The corresponding dependent variable x2 is obtained from the third linear equation, and the first pixel distance is obtained from (x2−x1).

In one embodiment, the step S570 calculating a second actual distance between a lower edge horizontal line of the reference module and an upper edge horizontal line of the module to be installed based on the second image comprises:
Step S571: calculating a pixel distance y1 from a center of the second image to the lower edge horizontal line of the reference module, and a pixel distance y2 from the center to the upper edge horizontal line of the module to be installed;
Step S572: obtaining a first proportional relationship r1 between the pixel distance and an actual distance of the range of the reference module, and a second proportional relationship r2 between the pixel distance and the actual distance of the range of the module to be installed;
Step S573: multiplying the pixel distance y1 by the first proportional relationship r1 to obtain the corresponding actual distance I, and m ultiplying the pixel distance y2 by the second proportional relationship r2 to obtain the corresponding actual distance II;
Step S574: obtaining the second actual distance based on the actual distance I and the actual distance II.

In one embodiment, obtaining a first proportional relationship r1 between the pixel distance and an actual distance of the range of the reference module in the step 572 comprises:

Calculating distances between adjacent second-type vertical lines within the range of the reference module based on positions of the second-type vertical lines of the reference module;
obtaining a pixel length of a cell within the range of the reference module in the second image based on the distances between all adjacent second-type vertical lines within the range of the reference module. For example, the distances between all adjacent second-type vertical lines are averaged, and the average value is used as the pixel length of the cell within the range of the reference module. Obtaining the first proportional relationship r1 between the pixel distance and an actual distance of the range of the reference module based on the pixel length and an actual length of the cell in the range of the reference module.

Obtaining a second proportional relationship r2 between the pixel distance and an actual distance of the range of the module to be installed in the step 572 comprises:

Calculating distances between adjacent second-type vertical lines within the range of the module to be installed based on positions of the second-type vertical lines of the module to be installed in the second image; obtaining a pixel length of a cell within the range of the module to be installed in the second image based on the distances between all adjacent second-type vertical lines within the range of the module to be installed. For example, the distances between all adjacent second-type vertical lines are averaged, and the average value is used as the pixel length of the cell within the module to be installed. Obtaining a second proportional relationship r2 between the pixel distance and an actual distance of the range of the module to be installed based on the pixel length and an actual length of the cell in the range of the module to be installed.

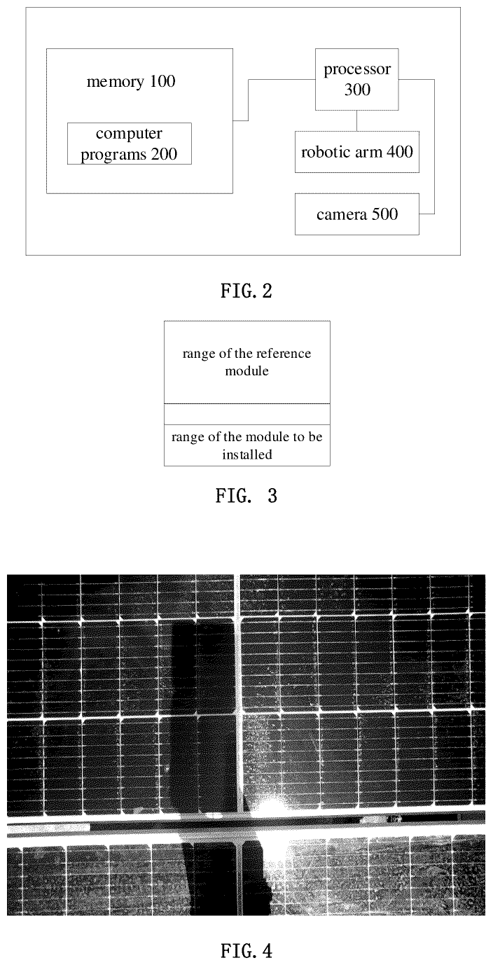

In one embodiment of the present application, as shown in FIG. 2, a module installation robot 10 comprises:
a robotic arm 400, which is configured to grasp, move, and adjust a module to be installed;
a camera 500, which is located at an end of the robotic arm, configured for obtaining an image containing a reference module and the module to be installed;
a memory 100, which is configured to store computer programs 200;
a processor 300, which is configured to implement the photovoltaic module installation methods based on surface linear features from any of above-mentioned embodiment when running the computer programs 200.

The memory 100 may be any internal storage unit and/or external storage device capable of storing data and programs, for example, a plug-in hard disk, a smart memory card (SMC), a secure digital (SD) card, or a flash memory card.

As needed, the processor 300 can be a central processing unit (CPU), a graphics processing unit (GPU), a digital signal processor (DSP), an application-specific integrated circuit (ASIC), a field programmable gate array (FPGA), a general-purpose processor or other logic devices, etc.

It should be noted that the above embodiments can be freely combined as needed. The above are only preferred embodiments of the present application. It should be noted that those skilled in the art can make several improvements and modifications without departing from the principles of the present application, and such improvements and modifications should also be considered within the scope of protection of the present application.

1. A photovoltaic module installation method based on surface linear features, which is used for a module installation robot, the module installation robot comprises a robotic arm and a camera located at an end of the robotic arm, characterized by comprising:
grasping a module to be installed via the robotic arm, moving the module to a fine-tuning position, and hovering it at the fine-tuning position, wherein the fine-tuning position is located above an installation location of the module to be installed and spaced from the installation location by a first preset distance;
obtaining a first image including a reference module and the module to be installed via the camera, wherein the reference module is a previously installed photovoltaic module immediately close to the module to be installed;
calculating an average angle between horizontal lines of the reference module and horizontal lines of the module to be installed in the first image, wherein the horizontal lines of the reference module and the module to be installed are formed by connection lines between multiple cells, and performing a first fine-tuning adjustment on the module to be installed based on the average angle so that the horizontal lines of the reference module and the horizontal lines of the module to be installed are parallel;
obtaining a second image including the reference module and the first fine-tuned module to be installed via the camera;
calculating a first actual distance between vertical lines of the reference module and vertical lines of the corresponding module to be installed, wherein the vertical lines of the reference module and the module to be installed are formed by connection lines between multiple cells, and a second actual distance between a lower edge horizontal line of the reference module and an upper edge horizontal line of the module to be installed based on the second image;
translating the module to be installed along a horizontal direction based on the first actual distance so as to align the vertical lines of the reference module with the vertical lines of the corresponding module to be installed;
translating the module to be installed along a vertical direction based on the second actual distance so as to maintain a second preset distance between the reference module and the module to be installed;
pressing the module to be installed downward to the installation location;
said calculating an average angle between horizontal lines of the reference module and horizontal lines of the module to be installed in the first image comprises:
performing a morphological opening operation on the first image, and then extracting edge horizontal lines of the two modules in the first image using a Hough detection algorithm;
obtaining intersection points between the edge horizontal lines and a first vertical detection line, wherein the first vertical detection line is a straight line located at a center of the first image and parallel to a Y-axis;
clustering the edge horizontal lines based on vertical coordinates of the intersection points to obtain a plurality of clusters, and identifying a position of the corresponding edge horizontal line by using a midpoint value of each cluster;
calculating an intermediate value between a topmost cluster and a bottommost cluster, wherein the edge horizontal lines of the clusters located above the intermediate value are determined as the edge horizontal lines of the reference module, and the edge horizontal lines of the clusters located below the intermediate value are determined as the edge horizontal lines of the module to be installed, thereby identifying the edges of the reference module and the module to be installed in the first image;
distinguishing the reference module and the module to be installed in the first image based on the edges;
calculating an average inclination angle of the horizontal lines of the reference module in the first image;
calculating an average inclination angle of the horizontal lines of the module to be installed in the first image;
obtaining the average angle between the horizontal lines of the reference module and the horizontal lines of the module to be installed based on the average inclination angle of the horizontal lines of the reference module and the average inclination angle of the horizontal lines of the module to be installed;
said calculating an average inclination angle of the horizontal lines of the reference module in the first image comprises:
extracting all horizontal lines of the reference module using a Hough detection algorithm, and obtaining an inclination angle for each horizontal line of the reference module;
obtaining intersection points between the horizontal lines and the first vertical detection line;
clustering the horizontal lines based on vertical coordinates of the intersection points to obtain a plurality of clusters;
performing a median filtering on inclination angles of the horizontal lines within each cluster, and constructing a first point set using the inclination angles of remaining horizontal lines after filtering and vertical coordinates of their intersection points between the first vertical detection line and the remaining horizontal lines after filtering; wherein for each point in the first point set, its horizontal coordinate is a vertical coordinate of the intersection point between the remaining horizontal lines after filtering and the first vertical detection line, and its vertical coordinate is the inclination angle of remaining horizontal lines after filtering;
fitting the first point set to obtain a first linear equation, wherein the average inclination angle of all horizontal lines of the reference module is equal to an intercept b1 of the first linear equation.

2-4. (canceled)

5. The photovoltaic module installation method based on surface linear features according to claim 1, characterized in that said calculating an average inclination angle of the horizontal lines of the module to be installed in the first image comprises:
extracting the horizontal lines of the module to be installed in the first image using a Hough detection algorithm, and obtaining an inclination angle for each horizontal line;
obtaining intersection points between the horizontal lines of the module to be installed and the first vertical detection line;
clustering the horizontal lines of the module to be installed based on vertical coordinates of the intersection points to obtain a plurality of clusters;
performing a median filtering on inclination angles of the horizontal lines within each cluster, and constructing a second point set using the inclination angles of remaining horizontal lines after filtering and vertical coordinates of their intersection points between the first vertical detection line and the remaining horizontal lines after filtering, wherein for each point in the second point set, its horizontal coordinate is a vertical coordinate of the intersection point between the remaining horizontal lines after filtering and the first vertical detection line, and its vertical coordinate is the inclination angle of remaining horizontal lines after filtering;
fitting the second point set with a second linear equation, wherein a slope of the second linear equation is equal to a slope of the first linear equation, which comprises:
substituting each point in the second point set into the second linear equation to obtain a corresponding intercept value of the second linear equation, and averaging all intercept values to obtain an intercept of the second linear equation;
wherein the average inclination angle of all horizontal lines of the module to be installed is equal to the intercept b2 of the second linear equation.

6. The photovoltaic module installation method based on surface linear features according to claim 1, characterized in that said calculating a first actual distance between vertical lines of the reference module and vertical lines of the corresponding module to be installed based on the second image comprises:
determining edges of the reference module and the module to be installed in the second image, and identifying the lower edge horizontal line of the reference module and the upper edge horizontal line of the module to be installed;
distinguishing the reference module and the module to be installed in the second image based on the edges, and determining a range of the reference module and a range of the module to be installed;
extracting a vertical line of the reference module and a vertical line of the corresponding module to be installed from the second image as an upper module reference line and a lower module reference line, respectively;
extracting vertical lines of the reference module and the module to be installed other than the upper module reference line and the lower module reference line from the second image;
using horizontal coordinate values of first-type intersection points between a first horizontal detection line and the vertical lines of the reference module to identify positions of corresponding vertical lines, and using horizontal coordinate values of second-type intersection points between a second horizontal detection line and the vertical lines of the module to be installed to identify positions of corresponding vertical lines; wherein the first horizontal detection line is a straight line located in the range of the reference module and parallel to an X-axis, and the second horizontal detection line is a straight line located in the range of the module to be installed and parallel to the X-axis;
calculating relative positions of the vertical lines of the reference module with respect to the upper module reference line, calculating relative positions of the vertical lines of the module to be installed with respect to the lower module reference line; and matching the vertical lines of the reference module and the module to be installed having same relative positions to form vertical line pairs;
calculating a first pixel distance between the vertical line of the reference module and the vertical line of the corresponding module to be installed based on positions of any two vertical lines among all vertical line pairs;
obtaining a second scaling ratio r2 between a pixel distance and an actual distance within the range of the module to be installed in the second image;
multiplying the first pixel distance by the second scaling ratio r2 to obtain the first actual distance.

7. The photovoltaic module installation method based on surface linear features according to claim 6, characterized in that said extracting a vertical line of the reference module and a vertical line of the corresponding module to be installed from the second image as an upper module reference line and a lower module reference line, respectively, comprises:
the second image comprises a first-type vertical line and a plurality of second-type vertical lines, wherein the first-type vertical line is wider than the second-type vertical line;
performing a morphological opening operation on the second image, and then extracting the first-type vertical line using a Hough detection algorithm, wherein the first-type vertical line located in the range of the reference module is used as the upper module reference line, and the first-type vertical line located in the range of the module to be installed is used as the lower module reference line.

8. The photovoltaic module installation method based on surface linear features according to claim 7, characterized in that said using horizontal coordinate values of first-type intersection points between a first horizontal detection line and the vertical lines of the reference module to identify positions of corresponding vertical lines comprises:
selecting the first horizontal detection line located at a center of the range of the reference module, and obtaining the first-type intersection points between the upper module reference line and the first horizontal detection line;
clustering horizontal coordinates of the first-type intersection points to obtain a plurality of clusters; obtaining a midpoint value of each cluster, averaging the midpoint values of all clusters, and using an average value as a position identifier of the upper module reference line;
said using horizontal coordinate values of second-type intersection points between a second horizontal detection line and the vertical lines of the module to be installed to identify positions of corresponding vertical lines comprises:
selecting the second horizontal detection line located at a center of the range of the module to be installed, and obtaining the second-type intersection points between the lower module reference line and the second horizontal detection line;
clustering horizontal coordinates of the second-type intersection points to obtain a plurality of clusters; obtaining a midpoint value of each cluster, averaging the midpoint values of all clusters, and using an average value as a position identifier of the lower module reference line.

9. The photovoltaic module installation method based on surface linear features according to claim 8, characterized in that said extracting vertical lines of the reference module and the module to be installed other than the upper module reference line and the lower module reference line from the second image comprises:
extracting the second-type vertical lines of the reference module and the second-type vertical lines of the module to be installed in the second image using a Hough detection algorithm;
said using horizontal coordinate values of first-type intersection points between a first horizontal detection line and the vertical lines of the reference module to identify positions of corresponding vertical lines comprises:
obtaining the first-type intersection points between the second-type vertical lines of the reference module and the first horizontal detection line;
clustering the second-type vertical lines of the reference module based on horizontal coordinates of the first-type intersection points to obtain a plurality of clusters, and using a midpoint value of each cluster as a position identifier of the second-type vertical line of the corresponding reference module;
said using horizontal coordinate values of second-type intersection points between a second horizontal detection line and the vertical lines of the module to be installed to identify positions of corresponding vertical lines comprises:
obtaining the second-type intersection points between the second-type vertical lines of the module to be installed and the second horizontal detection line;
clustering the second-type vertical lines of the module to be installed based on horizontal coordinates of the second-type intersection points to obtain a plurality of clusters, and using a midpoint value of each cluster as a position identifier of the second-type vertical line of the corresponding module to be installed.

10. The photovoltaic module installation method based on surface linear features according to claim 6, characterized in that said calculating a first pixel distance between the vertical line of the reference module and the vertical line of the corresponding module to be installed based on positions of any two vertical lines among all vertical line pairs comprises:
constructing a third point set, wherein points of the third point set correspond to the vertical line pairs, and the horizontal coordinate value of each point in the third point set is the horizontal coordinate value of the first-type intersection point, and the vertical coordinate value is the horizontal coordinate value of the second-type intersection point;
fitting the third point set to obtain a third linear equation, wherein an independent variable of the third linear equation is a position of the vertical line of the reference module in the vertical line pairs, and a dependent variable is a position of the vertical line of the corresponding module to be installed;
obtaining a corresponding dependent variable based on the third linear equation when the independent variable is a horizontal coordinate value of a center of the second image, and subtracting the independent variable value from the dependent variable value to obtain the first pixel distance.

11. The photovoltaic module installation method based on surface linear features according to claim 7, characterized in that said calculating a second actual distance between a lower edge horizontal line of the reference module and an upper edge horizontal line of the module to be installed based on the second image comprises:
calculating a pixel distance y1 from a center of the second image to the lower edge horizontal line of the reference module, and a pixel distance y2 from the center to the upper edge horizontal line of the module to be installed;
obtaining a first proportional relationship r1 between a pixel distance and an actual distance at the range of the reference module, and the second proportional relationship r2 between the pixel distance and the actual distance at the range of the module to be installed;
multiplying the pixel distance y1 by the first proportional relationship r1 to obtain the corresponding actual distance I;
multiplying the pixel distance y2 by the second proportional relationship r2 to obtain the corresponding actual distance II;
obtaining the second actual distance based on the actual distance I and the actual distance II.

12. The photovoltaic module installation method based on surface linear features according to claim 11, characterized in that said obtaining a first proportional relationship r1 between a pixel distance and an actual distance at the range of the reference module comprises:
calculating distances between adjacent second-type vertical lines at the range of the reference module based on positions of the second-type vertical lines of the reference module;
obtaining a pixel length of a cell at the range of the reference module in the second image based on the distances between all adjacent second-type vertical lines at the range of the reference module;
obtaining the first proportional relationship r1 between the pixel distance and the actual distance of the range of the reference module based on the pixel length and an actual length of the cell in the range of the reference module;
said obtaining a second proportional relationship r2 between the pixel distance and an actual distance of the range of the module to be installed comprises:
calculating distances between adjacent second-type vertical lines within the range of the module to be installed based on positions of the second-type vertical lines of the module to be installed in the second image;
obtaining a pixel length of a cell within the range of the module to be installed in the second image based on the distances between all adjacent second-type vertical lines within the range of the module to be installed;
obtaining a second proportional relationship r2 between the pixel distance and the actual distance of the range of the module to be installed based on the pixel length and an actual length of the cell in the range of the module to be installed.

13. A module installation robot, characterized by comprising:
a robotic arm, which is configured to grasp, move, and adjust a module to be installed;
a camera, which is located at an end of the robotic arm, configured for obtaining an image containing a reference module and the module to be installed;
a memory, which is configured to store computer programs;
a processor, which is configured to implement the photovoltaic module installation method based on surface linear features as described in any one of claim 1 to 12 when running the computer programs.
